(19) United States
(12) Patent Application Publication
(10) Pub. No.: US 2026/0050813 A1
(43) Pub. Date: Feb. 19, 2026

(54) DIFFERENTIABLE ANALOG QUANTUM COMPUTING FOR OPTIMIZATION AND CONTROL

(71) Applicant: UNIVERSITY OF MARYLAND, COLLEGE PARK, College Park, MD (US)

(72) Inventors: Xiaodi WU, Brookline, MA (US); Jiaqi LENG, Greenbelt, MD (US); Yuxiang PENG, Greenbelt, MD (US); Ming LIN, Bethesda, MD (US); Yiling QIAO, Greenbelt, MD (US)

(21) Appl. No.: 19/103,582

(22) PCT Filed: Aug. 18, 2023
(86) PCT No.: PCT/US2023/030550

§ 371 Date: Feb. 13, 2025

Related U.S. Application Data
(60) Provisional application No. 63/373,044, filed on Aug. 19, 2022.

(51) Int. Cl. G06N 10/60; G06F 17/13; G06N 10/20

(52) U.S. Cl. CPC G06N 10/60; G06F 17/13; G06N 10/20

(57) ABSTRACT

A system for differentiable analog quantum computing includes a processor, and a memory. The memory includes instructions stored thereon, which, when executed by the processor, cause the system to obtain an optimization problem represented by a time-dependent Hamiltonian, wherein the time-dependent Hamiltonian includes a trainable variable v; generate a loss function based on the time-dependent Hamiltonian; perform a differentiation of the loss function with respect to the trainable variable v for the time-dependent Hamiltonian; minimize the loss function to update the trainable variable v; and generate a control signal for a quantum device based on updating the trainable variable v.

### CROSS-REFERENCE TO RELATED APPLICATION/CLAIM OF PRIORITY

This application claims the benefit of, and priority to, U.S. Provisional Patent Application No. 63/373,044 filed on Aug. 19, 2022, the entire contents of which are hereby incorporated herein by reference.

### GOVERNMENT SUPPORT

This invention was made with government support under CCF1816695, CCF1942837, U.S. Pat. Nos. 1,840,864, and 1,910,940 awarded by the National Science Foundation, DESC0019040 and DESC0020273 awarded by the U.S. Department of Energy, and W911NF1910069 and W911NF2110026 awarded by the Department of the Army, Army Research Office. The government has certain rights in the invention.

### TECHNICAL FIELD

The present disclosure relates generally to quantum computing and operations, including quantum devices. More specifically, the present disclosure provides, for example, a system and method for differentiable analog quantum computing for optimization and control.

### BACKGROUND

Quantum computers generally have restricted hardware resources, which makes the implementation of large-scale quantum algorithms difficult. Implementing digital quantum circuits incurs non-negligible overhead.

Accordingly, there is interest in analog-oriented quantum computing for continuous optimization.

### SUMMARY

In an aspect of the present disclosure, a system for differentiable analog quantum computing is presented. The system includes a quantum computing system, a processor, and a memory. The memory includes instructions stored thereon, which, when executed by the processor, cause the quantum computing system to: obtain an optimization problem represented by a time-dependent Hamiltonian, wherein the time-dependent Hamiltonian includes a trainable variable v; generate a loss function based on the time-dependent Hamiltonian; perform a differentiation of the loss function with respect to the trainable variable v for the time-dependent Hamiltonian; minimize the loss function to update the trainable variable v; and generate a control signal for a quantum device based on update the trainable variable v.

In another aspect of the present disclosure, the instructions, when executed by the processor, may further cause the quantum system to perform a quantum gradient descent.

In another aspect of the present disclosure, the instructions, when executed by the processor, may further cause the quantum system to determine a differentiable loss function of the time-dependent Hamiltonian; and optimize the differentiable loss function.

In an aspect of the present disclosure, the time-dependent Hamiltonian may be parameterized by trainable variables.

In another aspect of the present disclosure, the quantum system may evolve through the time following the Schrödinger equation

$$\frac{d}{d t} x ( t ) = - i H ( v , t ) x ( t ) .$$

In an aspect of the present disclosure, the Hamiltonian may be of the form

$$H ( v , t ) = {H}_{c} + {\sum }_{j = 1}^{m} {u}_{j} ( v , t ) {H}_{j} .$$

In another aspect of the present disclosure, uⱼ(v, t) may be differentiable with respect to v for any t∈[0, T].

In an aspect of the present disclosure, the Hamiltonian of the quantum device may be of the form H(v, t), parameterized by tunable pulses.

In another aspect of the present disclosure, the instructions, when executed by the processor, may further cause the quantum system to generate an unbiased estimation of a gradient ∂ [symbol] /∂v.

In an aspect of the present disclosure, the instructions, when executed by the processor, may further cause the quantum system to estimate the integral using a Monte Carlo integration (MCI) technique.

In another aspect of the present disclosure, the unbiased estimation of gradient ∂ [symbol] /∂v may be generated by setting two layers of mini-batches, including an integration mini-batch with size bᵢₙₜ; and an observation mini-batch with size b_{obs}. The integration mini-batch may update parameters according to an estimation of derivatives on the time. The observation mini-batch may be configured to repeat experiments to improve measurement results.

An aspect of the present disclosure provides a method for quantum optimization. The method includes: obtaining an optimization problem represented by a time-dependent Hamiltonian, wherein the time-dependent Hamiltonian includes a trainable variable v; generating a loss function based on the time-dependent Hamiltonian; performing a differentiation of the loss function with respect to the trainable variable v for the time-dependent Hamiltonian; minimizing the loss function to update the trainable variable v; and generating a control signal for a quantum device based on update the trainable variable v.

In an aspect of the present disclosure, the method may further include determining a differentiable loss function of the time-dependent Hamiltonian; and optimizing the differentiable loss function.

In another aspect of the present disclosure, the time-dependent Hamiltonian may be parameterized by trainable variables.

In another aspect of the present disclosure, the quantum system may evolve through time following the Schrödinger equation

$$\frac{d}{d t} x ( t ) = - i H ( v , t ) x ( t ) .$$

In an aspect of the present disclosure, the Hamiltonian is of the form

$$H ( v , t ) = {H}_{c} + {\sum }_{j = 1}^{m} {u}_{j} ( v , t ) {H}_{j} .$$

In another aspect of the present disclosure, uⱼ(v, t) may be differentiable with respect to v for any t∈[0, T].

In another aspect of the present disclosure, the Hamiltonian of the quantum device may be of the form H(v, t), and is parameterized by tunable pulses.

In another aspect of the present disclosure, the method may further include generating an unbiased estimation of a gradient ∂ [symbol] /∂v.

In an aspect of the present disclosure, the method may further include estimating the integral using a Monte Carlo integration (MCI) technique.

An aspect of the present disclosure provides a method for quantum optimization. The method includes obtaining an ordinary differential equation (ODE) using a quantum simulator, where

$$H ( v , t ) = {H}_{c} + {\sum }_{j = 1}^{m} {u}_{j} ( v , t ) {H}_{j} ;$$

optimizing a loss function of the ODE to update the trainable variable v, using the quantum simulator, where [symbol] = [symbol] ψ(T)|M|ψ(T) [symbol] ; estimating a gradient ∂ [symbol] /∂v; using the quantum simulator; updating the trainable variable v based on the estimated gradient ∂ [symbol] /∂v; generating a control signal for a quantum device based on updating the trainable variable v; and controlling the quantum device using the control signal.

Further details and aspects of exemplary aspects of the present disclosure are described in more detail below with reference to the appended drawings.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying drawings of which:

FIG. 1 is a diagram of an exemplary system for differentiable analog quantum computing, in accordance with examples of the present disclosure;

FIG. 2 is a flow diagram illustrating differentiable analog quantum computing using the system of FIG. 1, in accordance with examples of the present disclosure;

FIG. 3 is an algorithm for estimating gradients using the system of FIG. 1, in accordance with examples of the present disclosure;

FIG. 4A is a flow diagram illustrating an example experiment on quantum optimization using the system of FIG. 1, in accordance with examples of the present disclosure;

FIG. 4B is a graph illustrating results of the example experiment of FIG. 4A, in accordance with examples of the present disclosure;

FIG. 5A is a flow diagram illustrating an example experiment on quantum optimization using the system of FIG. 1, in accordance with the present disclosure;

FIG. 5B is a graph illustrating results of the example experiment of FIG. 5A, in accordance with examples of the present disclosure;

FIG. 6A is a graph illustrating results of an example experiment applying the system of FIG. 1 to state preparation |+ [symbol] , in accordance with examples of the present disclosure;

FIG. 6B is a graph illustrating results of an example experiment applying the system of FIG. 1 to state preparation |¢⁺ [symbol] , in accordance with examples of the present disclosure;

FIG. 6C is a graph illustrating results of an example experiment applying the system of FIG. 1 to gate synthesis of X gate, in accordance with examples of the present disclosure;

FIG. 6D is a graph illustrating results of an example experiment applying the system of FIG. 1 to gate synthesis of CNOT gate, in accordance with examples of the present disclosure; and

FIG. 7 is a diagram of a method for the quantum computing system of FIG. 1, in accordance with examples of the present disclosure.

### DETAILED DESCRIPTION

The present disclosure relates generally to quantum computing and operations, including quantum devices. More specifically, the present disclosure provides, for example, a system and method for differentiable analog quantum computing for optimization and control.

Aspects of the present disclosure are described in detail with reference to the drawings wherein like reference numerals identify similar or identical elements.

Although the present disclosure will be described in terms of specific examples, it will be readily apparent to those skilled in this art that various modifications, rearrangements, and substitutions may be made without departing from the spirit of the present disclosure. The scope of the present disclosure is defined by the claims appended hereto.

For the purpose of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

Quantum computing has promised unprecedented improvement in the computational ability to tackle classically intractable problems. Despite the rapid development of quantum hardware, near-term quantum computers are still likely to have very restricted hardware resources, where the limited number of “qubits” and non-negligible machine noises would impede the implementation of large-scale quantum algorithms. Research results in both computer science and physics suggests a promising approach of designing resource-efficient Noisy Intermediate-Scale Quantum (NISQ) applications by breaking quantum circuit abstractions and directly designing applications at the pulse-level control of quantum machines. The benefits of this analog-oriented approach have been witnessed in the history of classical analog computing that predates digital computing due to relaxed hardware requirements and plays an important role in domain applications such as simulation.

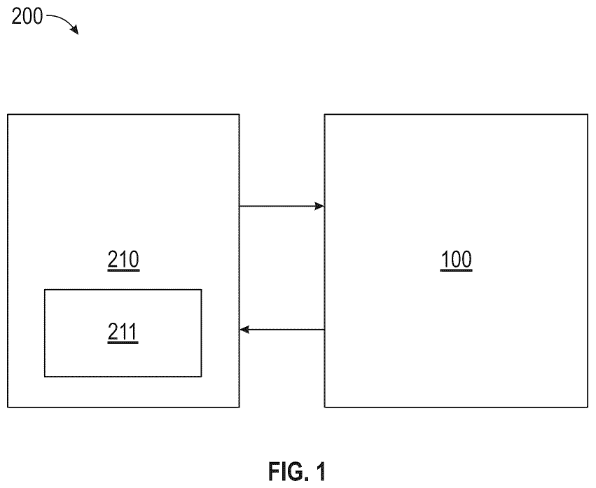

Referring to FIG. 1, a diagram of an exemplary system 200 for optimization using gradient descent, in accordance with the present disclosure, is shown.

Variational Quantum Algorithm (VQA) may be executed on NISQ computers, with a few examples such as the Variational Quantum Eigensolver (VQE) and quantum approximate optimization algorithm (QAOA). Specifically, VQA uses parametrized quantum models to characterize loss functions, in particular those from quantum physics, which are potentially intractable for classical computing. These parameters will then be optimized, usually through gradient-based approaches, to minimize the given loss function. Parameterized quantum models may include quantum circuits where each gate is parameterized by classical variables. This framework may be referred to as differentiable digital quantum computing.

Although parameterized quantum circuits are designed for NISQ applications, implementing (digital) quantum circuits still incurs non-negligible overheads, which significantly restricts the size of parametrized circuits that can be executed faithfully on NISQ machines. Moreover, the current parameterization in VQAs is also largely restricted by available parameterized gates and how they compose circuits, which in turn limits the expressive power of VQAs. A natural alternative to the current digital parameterization is to perform VQA directly on parametrized analog signals (pulses), either on digital quantum machines with pulse-level controls, or on general analog quantum hardware. Parameterized analog pulses have the potential for more efficient NISQ implementation and better expressiveness, which could be a more favorable parameterization for NISQ applications even when digital quantum gates are available.

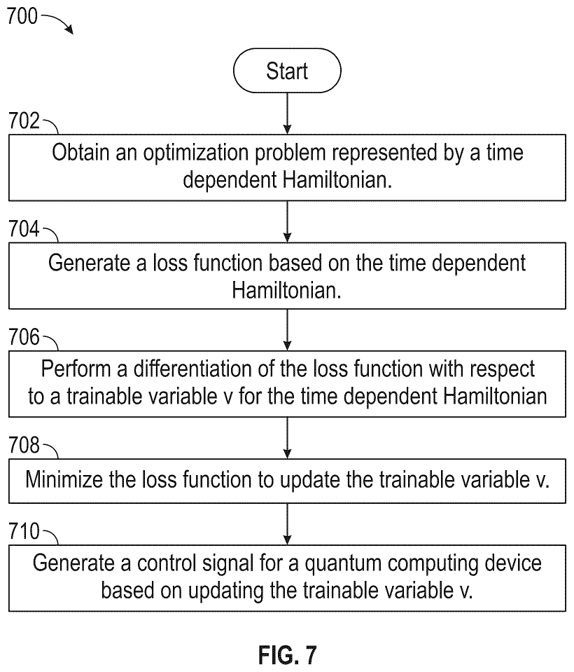

The system 200 for optimization may include a quantum computing system 100, a processor 210, and a memory 211 including instructions stored thereon, which, when executed by the processor 210, cause the quantum computing system 100 to perform the steps of method 700 of FIG. 7.

The processor 210 may be connected to a computer-readable storage medium or a memory 211. The computer-readable storage medium or memory 211 may be a volatile type of memory, e.g., RAM, or a non-volatile type of memory, e.g., flash media, disk media, etc. In various aspects of the disclosure, the processor 210 may be any type of processor such as a quantum processor, a digital signal processor, a microprocessor, an application-specific integrated circuit (ASIC), a graphics processing unit (GPU), a field-programmable gate array (FPGA), or a central processing unit (CPU).

In aspects of the disclosure, the memory 211 can be a quantum memory, random access memory, read-only memory, magnetic disk memory, solid-state memory, optical disc memory, and/or another type of memory. In some aspects of the disclosure, the memory 211 can be separate from the processor and can communicate with the processor wirelessly, or through communication buses of a circuit board and/or through communication cables such as serial ATA cables or other types of cables. The memory 211 includes computer-readable instructions that are executable by the processor 210 to operate the processor. In other aspects of the disclosure, the system 200 may include a network interface to communicate with other computers or to a server. A storage device may be used for storing data.

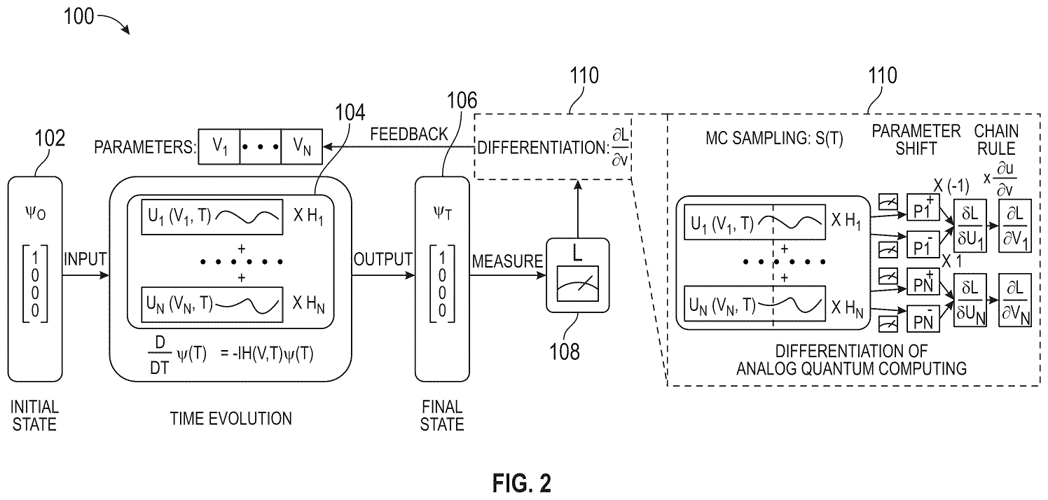

Referring to FIG. 2, a flow diagram of differentiable analog quantum computing is shown. Quantum systems have states, governing equations, and observations, so there naturally exist plenty of optimization, control, and learning problems for quantum computing. The disclosed technology provides a differentiable framework to compute the gradients of parametrized analog control signals on quantum computers, based on a forward simulation with stochastic sampling.

In this 2-qubit example, the system starts with an initial ground state ψ₀ 102 of dimension 4=2² and evolves through the time in step 104 following the Schrödinger equation:

$$\frac{d}{d t} x ( t ) = - i H ( v , t ) x ( t ) .$$

The dynamics of this quantum system are controlled by specifying the time-dependent Hamiltonian H(v, t), parameterized by trainable variables v. In the end of the process 106, the system is measured and a real-valued loss value, [symbol] 108 is obtained. The derivatives are computed as in the right box 110. Quantum computers cannot store computational graphs, so a time t is sampled in the forward simulation and apply the parameter shift rule to compute the gradients. The derivatives are then used in the feedback loop to update v optimizing [symbol] .

A qubit (or quantum bit) is the analogue of a classical bit in quantum computation. It is a two-level quantum-mechanical system described by vectors in the Hilbert space [symbol] . Dirac notation |ψ [symbol] is used to denote quantum states (i.e., unit vectors) ψ in [symbol] . For example, the classical “0” and “1” are represented by:

$$\vert 0 〉 = [ \begin{matrix}1 \\ 0\end{matrix} ] and \vert 1 〉 = [ \begin{matrix}0 \\ 1\end{matrix} ] .$$

One qubit states may be in any linear combination of |0 [symbol] and |1 [symbol] , which is called superposition. An n-qubit state is a unit vector in the Kronecker tensor product ⊗ of n single-qubit Hilbert spaces, i.e.,

$$ℋ = {⊗}_{i = 1}^{n} {ℂ}^{2} ≅ {ℂ}^{{2}^{n}} ,$$

whose dimension is exponential in n. For an n by m matrix A and a p by q matrix B, their Kronecker product is an np by mq matrix where (A⊗B)_{pr+u,qs+v}=A_{r,s}B_{u,v}. The complex conjugate transpose of |ψ [symbol] is denoted as [symbol] ψ|=|ψ [symbol] ^{†} († is the Hermitian conjugate). Therefore, the inner product of ϕ and ψ could be written as [symbol] ϕ|ψ [symbol] .

The time evolution of quantum states under the Schödinger equation is specified by the (time-dependent) Hermitian matrix H(t) over the corresponding Hilbert space, known as the Hamiltonian of the quantum system. Single-qubit Hamiltonians may include the Pauli matrices:

$$I = [ \begin{matrix}1 & 0 \\ 0 & 1\end{matrix} ] , X = [ \begin{matrix}0 & 1 \\ 1 & 0\end{matrix} ] , Y = [ \begin{matrix}0 & - i \\ i & 0\end{matrix} ] , Z = [ \begin{matrix}1 & 0 \\ 0 & - 1\end{matrix} ] .$$

Similarly, a multi-qubit Hamiltonian can be built from the Pauli group consisting of tensor products of Pauli matrices. Xⱼ (Yⱼ, Zⱼ) for a multi-qubit Hamiltonian indicates the tensor product of multiple identity matrices while the j-th operand is X (Y, Z), which represents operations on the j-th subsystem.

Quantum measurement refers to the procedure of extracting classical information from quantum systems. It is characterized by a Hermitian matrix M called the observable. Measuring a quantum state |ψ [symbol] with observable M is modeled as a random variable whose expectation value is [symbol] ψ|M|ψ [symbol] .

Most computational tasks in quantum simulation and control, like finding the ground state of a physics system, can be formulated as the following optimization problem. Given a quantum observable M and an initial state 102 |ψ(0) [symbol] =|ψ₀ [symbol] , is sought for a parameter vector v by minimizing the loss function:

$$ℒ = 〈 ψ ( T ) \vert M \vert ψ ( T ) 〉 ,$$

where the evolution of |ψ(t) [symbol] from t=0 to t=T subject to the Schrödinger equation. Here, H(v, t) is a Hamiltonian parametrized by v with form:

$$H ( v , t ) = {H}_{c} + {\sum }_{j = 1}^{m} {u}_{j} ( v , t ) {H}_{j} ,$$

where m is the number of control pulses, H_{c} is a time-independent Hamiltonian (e.g. Pauli matrices), Hⱼ are tensor products of Pauli matrices, and the range of uⱼ(v, t) is [symbol] . Additionally, uⱼ(v, t) must be differentiable with respect to v for any t∈[0, T]. The loss function [symbol] is hence differentiable. The restriction of Hⱼ can be loosened to general time-independent Hamiltonians if the quantum simulators are powerful enough.

With specific M and |ψ₀ [symbol] , optimization problem minᵥ [symbol] with post-processing can encode many essential classical and quantum problems. For example, any classical optimization of f(x) over n-bit integers x can be formulated as M=Σₓf(x) |x [symbol] [symbol] x|.

Abstract Quantum Analog Machines (AQAMs) may be used as the computational model. An AQAM optimizing the above loss function should be capable of consecutively: (1) evolving under H(v, t) for any v and time interval [t₁, t₂]⊂[[0, T]; (2) evolving under constant Hamiltonian Hⱼ for time duration τ (effectively applying unitary transformation e^{-iH}^{ⱼ}^{τ}); (3) preparing |ψ₀ [symbol] ; and (4) measuring with observable M. For realistic quantum devices, AQAMs need to be designed accordingly.

A trivial AQAM directly employs the Hamiltonian of a quantum device as H(v, t), parameterized by tunable pulses. In most realistic quantum devices, multi-qubit interactions are not tunable and weak compared to tunable single-qubit Hamiltonians. Thus Hⱼ can be simulated with high fidelity. The disclosed method is robust against imprecise simulations of H(v, t) and Hⱼ. Hence the trivial AQAMs are usually suitable for realistic quantum devices.

The disclosed formulation of the problem via analog quantum computing is a generalization of the formulation via parameterized circuits. For example, a series of parameterized Pauli rotation gates R_{P}_{ⱼ}(θⱼ)=exp−i(θⱼ/2)Pⱼ can be realized by H(v, t)=Σⱼvⱼ1ⱼ(t)Pⱼ with valuation vⱼ=0ⱼ/2, where 1ⱼ is the indicator function of [j, j+1]. However, simulating analog quantum computing via quantum circuits requires much longer time on nowadays devices, hence is unrealistic. So direct analog quantum computing provides the benefit of being able to exploit near-term quantum devices much better than quantum circuits.

The quantum SGD scheme for computing gradients on AQAMs is illustrated in this section, with its correctness, efficiency, and robustness discussed in the following sections.

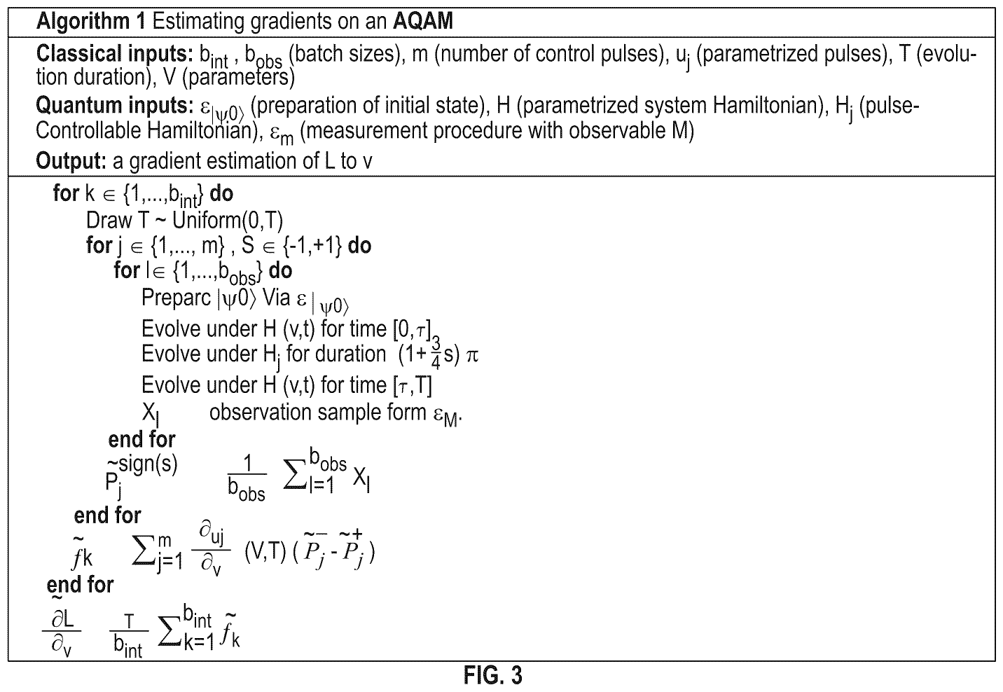

Mini-batches may be used to deal with the gradients, by setting two layers of mini-batches: (1) an integration mini-batch with size bᵢₙₜ; (2) an observation mini-batch with size b_{obs}. The integration mini-batch updates parameters according to the estimation of derivatives on the sampled time. The observation mini-batch repeats experiments to generate more precise measurement results. The scheme is illustrated in Algorithm 1 (FIG. 3).

The forward and backward propagation of the SGD scheme is depicted in FIG. 2. The inner loop may be the only procedure on the quantum machine. A difference of this procedure as compared with the estimation of loss function [symbol] is the inserted evolution under Hⱼ, which is beneficial in the error analysis.

The system 100 uses Algorithm 1 (FIG. 3) to generate an unbiased estimation of the gradient ∂ [symbol] /∂v, and hence establishes its correctness.

The derivative of [symbol] to parameters v is:

$$\frac{\partial ℒ}{\partial v} = {\int }_{0}^{T} d τ {\sum }_{j = 1}^{m} \frac{\partial {u}_{j}}{\partial v} ( v , τ ) ( {p}_{j}^{-} ( T ) - {p}_{j}^{+} ( τ ) ) .$$

$${p}_{j}^{\pm } ( t ) = 〈 {ψ}_{0} \vert {U}_{v}^{†} ( t , 0 ) {e}^{i {H}_{j} ( 1 \pm \frac{3}{4} ) π} {U}_{v}^{†} ( T , t ) M {U}_{v} ( T , t ) {e}^{- i {H}_{j} ( 1 \pm \frac{3}{4} ) π} {U}_{v} ( t , 0 ) 〉 {ψ}_{0}$$

where Uᵥ(t₂, t₁) denotes the time evolution operator for time interval [t₁, t₂] under Hamiltonian H(v, t).

The above formula may be interpreted as a direct application of the chain rule over functional derivatives ∂ [symbol] /∂uⱼ and partial derivatives ∂uⱼ/∂v, since

$$\frac{δℒ}{δ {u}_{j}} ( v , t ) = {p}_{j}^{-} ( t ) - {p}_{j}^{+} ( t )$$

by the parameter shift rule, which is a technique for evaluating commutators of Hermitian by quantum processes.

The system 100 uses Algorithm 1 (FIG. 3) to estimate the integral via Monte Carlo integration (MCI) technique. The sampling of MCI has finite variances when uⱼ(v, t) has bounded derivatives to v. Hence MCI converges at rate O

$$( {b}_{int}^{- \frac{1}{2}} ) .$$

Other numerical integral methods are also applicable here for different conditions on uⱼ and Hⱼ, and may have better convergence rates than MCI. MCI is presented here because MCI has good generalization and simplicity. Additionally, similar ideas developed in this section have also appeared in the circuit model, whereas everything is developed in the analog quantum computing model.

Overall, the forward and backward propagation of differentiation of [symbol] are depicted in FIG. 2. Since the parameterization of uⱼ is arbitrary, a typical treatment is using a Fourier basis or a Legendre basis as the support of the parameterization. Neural networks are also suitable for pulse generation with gradients that are easy to compute via backpropagation.

The resource consumption of the classical-quantum hybrid approach has two aspects: the classical and the quantum sides. The computation, as described in the algorithm of FIG. 3, has O (bᵢₙₜb_{obs} m) numerical calculations. On the quantum side, the sampling process assessing the loss function and its derivatives takes O (T) time each. The total running time on a quantum computer then is O (bᵢₙₜb_{obs} mT). Almost on every architecture of quantum devices, the number of control signals m is at most quadratic in the number of qubits n showing excellent scalability of the disclosed approach. The approach could in principle be readily applied to the most advanced existing quantum systems (e.g., with n of about 60). This is in sharp contrast to the case of GRAPE and CRAB algorithms, which rely on classical simulation of quantum systems with an exponential cost in n. For instance, the associated classical computation cost for n is about 60 (i.e., at least 260) is prohibitively high, almost reaching the limit of supercomputers today.

The goal is to optimize the loss function assessed on a realistic and noisy quantum machine, whose capabilities of evolving under H(v, t) and Hⱼ are imperfect.

The actual Hamiltonian of the quantum device may deviate from the description H(v, t), and the simulation of Hⱼ may be imprecise due to weak non-tunable terms in H_{c}. The algorithm of FIG. 3 well approximates the gradient of loss function of the actual devices.

An advantage of the algorithm of FIG. 3 is that even though the realization of Hamiltonian H(v, t) built in the AQAM is imperfect, the quantum part is executed on the actual quantum machine following the accurate Hamiltonian Ĥ(v, t). As a result, the output of the algorithm of FIG. 3 well approximates the gradient for the actual quantum machine.

Let [symbol] /∂v denote the accurate gradient of the loss function of the quantum machine, ∂ [symbol] /∂v denote the estimated gradient via the algorithm of FIG. 3, and ∥⋅∥ represent the matrix spectral norm, then

$$\vert \frac{\partial ℒ}{\partial v} - \frac{\hat{\partial ℒ}}{\partial v} \vert \leq 2 ‖ M ‖ T {max}_{τ ∈ [ 0 , T ]} ‖ \frac{\partial H}{\partial v} ( v , τ ) - \frac{\partial \hat{H}}{\partial v} ( v , τ ) ‖ .$$

In other words, the algorithm of FIG. 3 can optimize the control pulses without a precise understanding of the machine Hamiltonian, if the difference H(v, t)−Ĥ(v, t) varies slowly with respect to v.

On the contrary, relying solely on the Hamiltonian H(v, t) built in the abstract quantum analog machine (e.g., the classical simulation of quantum systems in GRAPE or CRAB), the approximation error could be as large as the difference of H(v, t)−Ĥ(v, t), a potentially large term compared with the derivative with respect to v. This particular advantage of algorithm 1 (FIG. 3), according to the present disclosure, is due to executing the algorithm on the actual quantum machine, such as an transmon device.

Similar to the circuit case, the systematic error caused by the imprecise evolution under Hⱼ is bounded by the error sum in each evolution under Hⱼ for duration

$$( 1 \pm \frac{3}{4} ) π ,$$

which is usually small.

Many important optimization problems in both physics and combinatorics that allow variational solutions can be formulated easily in the framework according to the present disclosure. For example, finding the ground state of physics systems can be solved by variational quantum eigen solver (VQE) (e.g.), and searching for the max-cut of graphs can be approximated by quantum approximate optimization algorithms (QAOA). Replacing parameterized circuits by AQAMs in existing variational quantum algorithms leads to significantly improved convergence based on numerical experiments on a classical simulator.

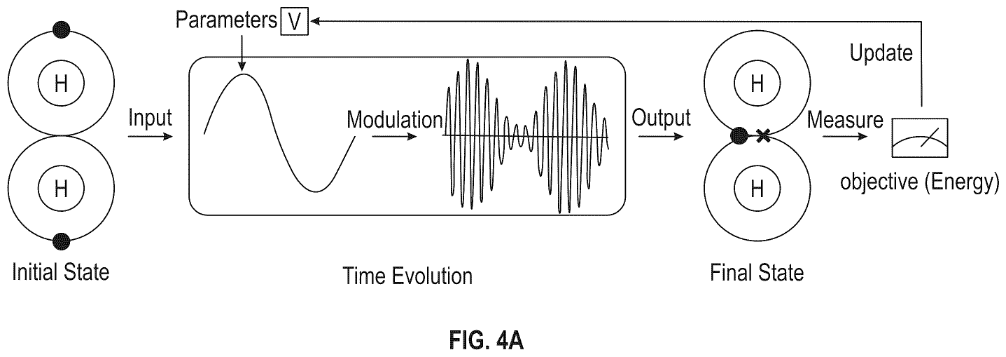

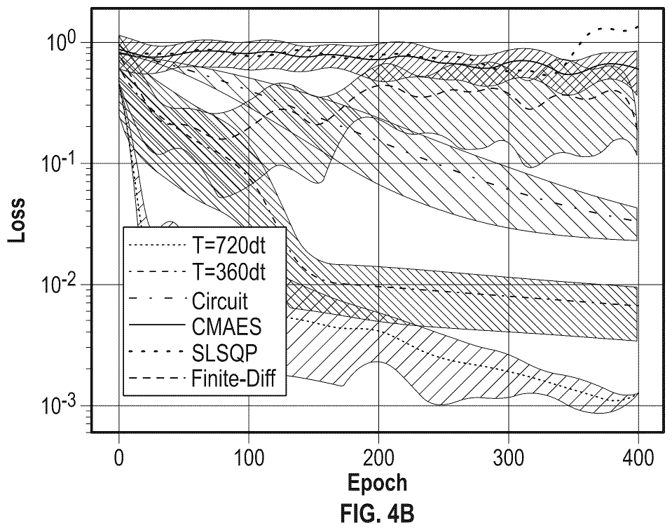

Referring to FIGS. 4A and 4B, a diagram and graph are shown of an example application of FIG. 2 showing experimental results on the H₂ ground energy search. Loss function is the difference of the evaluated energy to the ground energy of H₂, with a lower loss being more desirable. The disclosed method with the same pulse duration (720 dt) or less (360 dt) converges more than 10 times faster than the circuit model. Loss function is the difference of the evaluated cut size to the maximal cut size, the lower the better. The disclosed method outperforms the others by orders of magnitude.

The Hamiltonian of a H₂ molecule is expanded with Pauli matrices in the form H_{H}_{₂}=α₀ [symbol] +α₁Z₁Z₂+α₂X₁X₂+α₃Z₁+α₄Z₂, where αᵢ is a scalar weight and the ground state |ψ [symbol] has the minimal energy, defined by [symbol] [symbol] ψ|H_{H}_{₂}|ψ [symbol] .

Embodiments of the present disclosure include a system with a quantum device having or employing an AQAM. For example, a quantum device, such as trapped ion system, a superconducting system, and/or a transmon device (e.g., an IBM® transmon system), may be used with a AQAM as described herein. Embodiments of an AQUAM quantum device may contain 2 qubits and 4 input pulses uⱼₖ(t), and can evolve under:

$$H ( t ) = {H}_{s y s} + {\sum }_{j , k ∈ \{ 0 , 1 \}} {ℳ}_{j k} ( {u}_{jk} , t ) {X}_{j} .$$

Here H_{sys} is a constant Hamiltonian. The input pulses to the quantum devices are uⱼₖ(t) which are complex values with norm less than 1. These pulses are modulated by the built-in modulation procedure [symbol] ⱼₖ of the quantum devices when executed on the real machine. Since the tunable terms have Hamiltonian Xⱼ, the AQUAM quantum device needs to be able to evolve under Xⱼ. For example, this is realizable on IBM's® machines because H_{sys} is much weaker than the microwave input pulses for each qubit in form Xⱼ, ensuring a high fidelity simulation of Hamiltonian Xⱼ on real machines. Additionally, the AQUAM quantum device must support initializing in state |00 [symbol] and measuring with M=H_{H}_{₂}, and these procedures are easy to implement for IBM's® machines. The parameterization

$${u}_{j k} ( v , t ) = 𝒩 ( {\sum }_{l = 0}^{d} ( {v}_{jkl 0} + i {v}_{jkl 1} ) \cdot {P}_{l} ( \frac{2 t}{T} - 1 ) )$$

makes the pulse norms less than 1, where

$$𝒩 ( 0 ) = 0 , 𝒩 ( z ) = \frac{S ( \vert z \vert )}{\vert z \vert} z$$

for z≠0 is a differentiable normalization function restricting the norm,

$$S ( x ) = \frac{1 - {e}^{- x}}{1 + {e}^{- x}}$$

is the shifted sigmoid function, T is the duration, and Pₗ is the l-th Legendre polynomial.

A parameterized circuit is proposed as layered tunable single qubit rotations and fixed cross-resonance gates, which are compiled to pulses and sent to the IBM® quantum devices. The one-layer experiments over two qubits have cross resonance gates compiled to pulses with duration around 720 dt where d [symbol] =0.22 ns. Which is matched in the experiments by setting T=720 dt. Additionally, the approach is tested with only half the duration, T=360 dt.

Referring to FIG. 4A, an example workflow diagram is shown for an analog-ansatz-based VQE for a H₂ system for a H₂ ground energy search. The disclosed approach is compared to circuit VQE, finite difference method, simultaneous perturbation stochastic approximation (SPSA), and derivative-free methods (CMAES and SLSQP) with the AQAM quantum device on a classical simulator. The experiment results are displayed in FIG. 4B.

Referring to FIG. 4B, a graph is shown of the results of the example workflow diagram of FIG. 4A. The circuit VQE converges to [symbol] =0.02, while the disclosed approach decreases lower: at 400 epoch, with 720 dt it decreases to less than 0.002, and with 360 dt it decreases to 0.01. In general, the disclosed approach according to the present disclosure is over 10 times more accurate than the circuit VQE, and 100 times more accurate than the traditional derivative-free methods. The finite difference method and SPSA do not converge because of the intrinsic randomness of quantum measurements at a relatively small observation mini-batch (b_{obs}=100), which would be amplified by the small difference length. With a large enough observation mini-batch, the gradients evaluated by the finite difference method have about 3% relative difference to the gradients evaluated by the disclosed approach. These results exhibit the advantages of the disclosed differentiable analog framework compared to circuit model and derivative-free analog models.

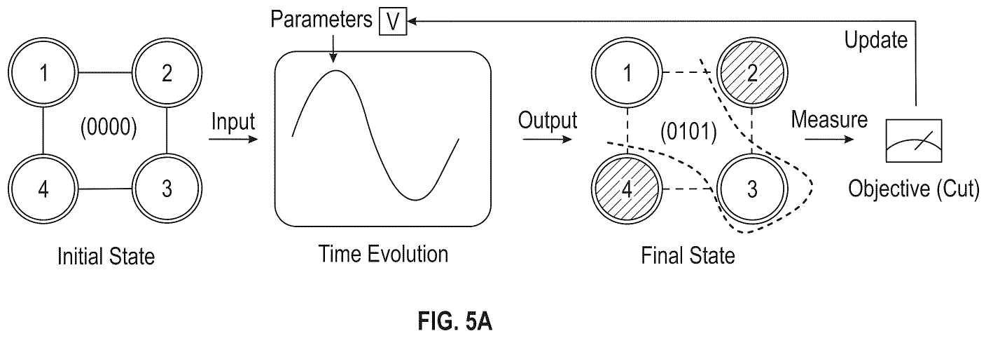

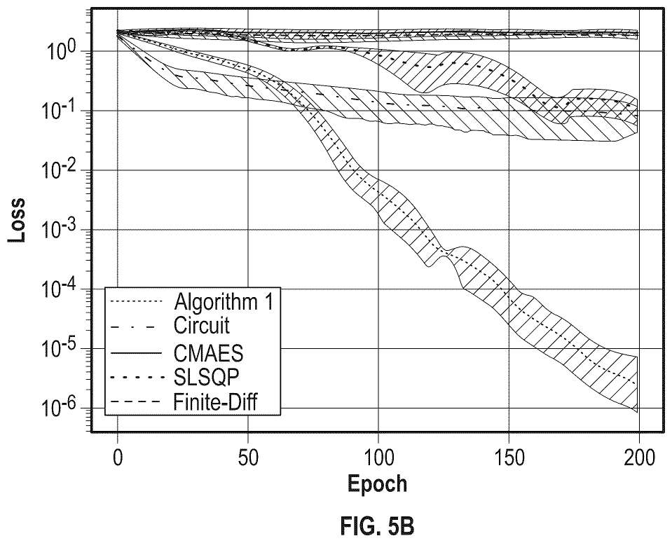

Referring to FIG. 5A, an example workflow diagram is shown of an analog-ansatz-based QAOA for finding an approximate max cut. With a corresponding AQAM, the disclosed approach achieves a significantly better convergence when using QAOA to approximate solutions for the MaxCut problem, an NP-complete problem.

Given a graph G={E, V} where V is the vertex set and E={(i, j)} contains all the edges, the goal is to partition the vertices into two sets (V₀, V₁) so that the number of edges between the two sets is maximized. A cut of an n-node graph G is represented by an n-bit string s=b₁b₂Ibₙ, with bⱼ∈{0,1} representing in which set the j-th vertex is. The computational basis |s [symbol] in an n-qubit register is used to represent the cut s. A maximum cut |s [symbol] maximizes the expected cut size [symbol] s|C|s [symbol] , where

$$C = \frac{1}{2} {\sum }_{( j , k ) ∈ E} {C}_{j , k} ,$$

$${C}_{j , k} = 𝕀 - {Z}_{j} {Z}_{k} .$$

The system optimizes a p-layer circuit ansatz

$$U ( β , γ ) = {\prod }_{j = 1}^{p} {e}^{- i {β}_{j} B} {e}^{- i {γ}_{j} C} ,$$

where

$$B = {\sum }_{j = 1}^{n} {X}_{j}$$

with p=2 set as a baseline.

To have a fair comparison, a Cut-AQAM is designed, corresponding to the above circuit:

$$H ( t ) = \frac{1}{2 π} {\sum }_{j = 1}^{4} ( {u}_{j 0} ( t ) {C}_{j , j + 1} + {u}_{j 1} ( t ) {X}_{j} ) .$$

The input pulses are real functions uⱼₖ(t), where the energy input is restricted by requiring |uⱼₖ|≤1. Cut-AQAM natively supports evolving merely under C_{j,j+1} or Xⱼ by setting uⱼₖ as indicator functions and must support initializing in state |0 [symbol] and measuring with observable C. In the experiment, the duration T=4 is set within which the circuit QAOA can be realized by Cut-AQAM. A normalized linear combination of Legen're's polynomials is used to parameterize uⱼₖ(v, t).

Referring to FIG. 5B, a graph of example results on finding the max cut for the 4 vertices circular graph of FIG. 5A is shown. The circuit QAOA and SLSQP converge to 0.08 at 200 epoch, while the disclosed approach converges to 2.6×10⁻⁶. Finite difference method, SPSA, and CMAES do not converge to a value less than 1. Since Cut-AQAM does not have a high frequency modulation, SLSQP also converges close to 0, but is slower than the disclosed approach. Larger experiments for up to 11 qubits were conducted to show good scalability and better performance compared to circuit QAOA.

Quantum control problems fall into two categories: 1) state preparation, to steer a given initial state into a target final state; and 2) gate synthesis, to effect a specific unitary transformation (quantum gate) in the system.

To prepare the target state |ψₜₐᵣ [symbol] from certain fixed initial state, a parameter vector v is desired that minimizes the loss function with the observable M= [symbol] −|ψₜₐᵣ [symbol] [symbol] ψₜₐᵣ|. There are two tasks to consider: 1) to prepare the state |+ [symbol] from |0 [symbol] ; and 2) to prepare the two-qubit maximally entangled state |Φ⁺ [symbol] from |00 [symbol] . In both tasks, the loss function is readily computed as the measurement merely involves local Pauli operators, and can be carried out on the AQAM quantum device.

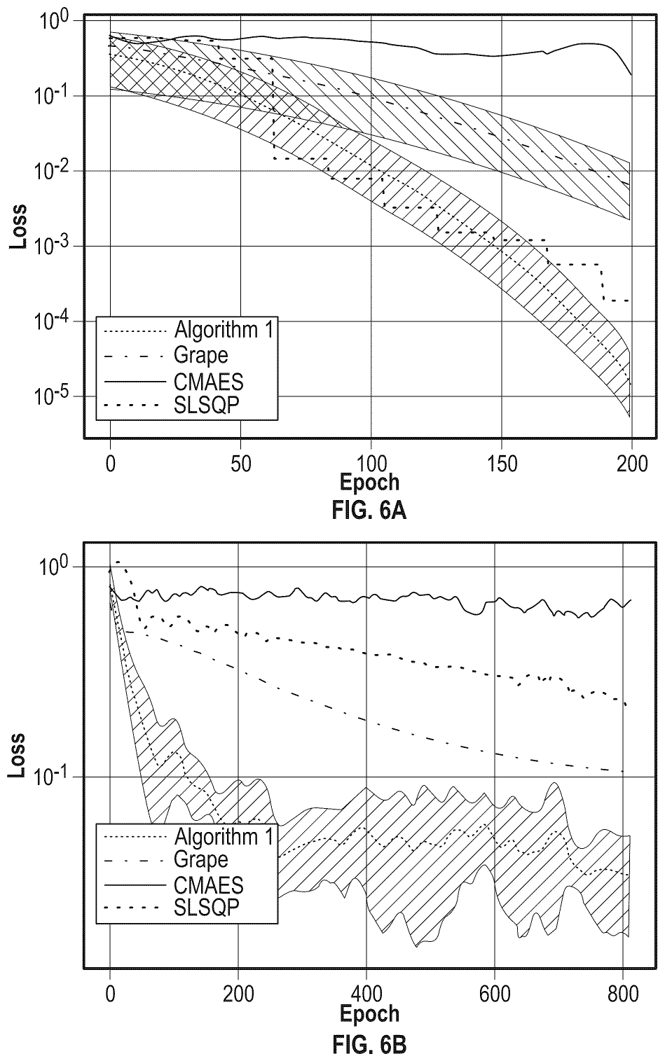

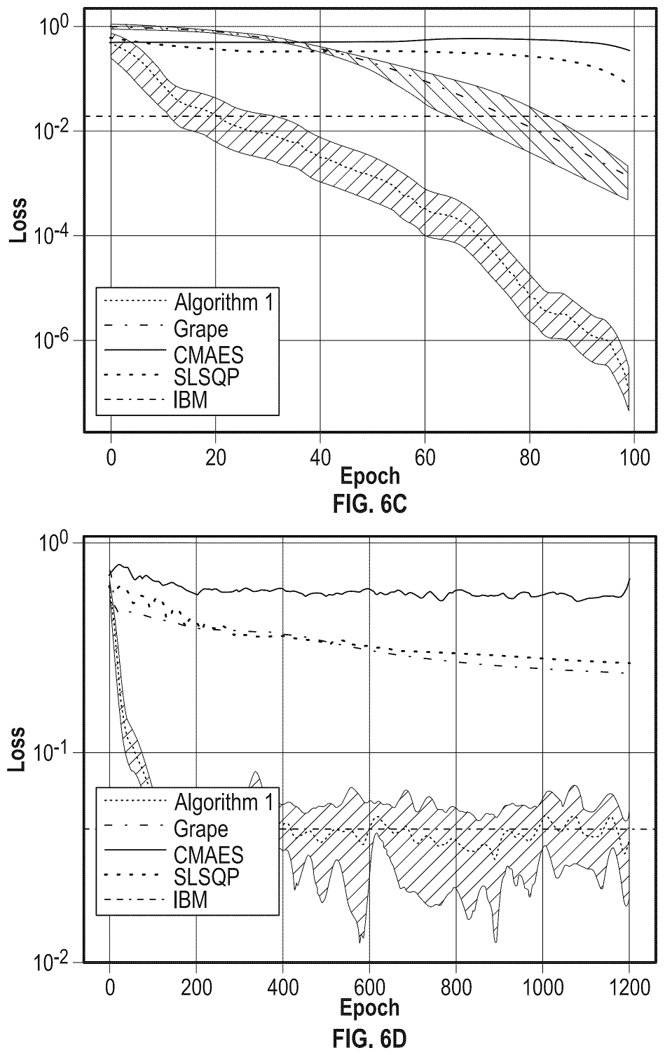

In the numerical experiments, the pulse duration is fixed as T=20 dt for the |+ [symbol] state, and T=1200 dt for the |Φ⁺ [symbol] state. The disclosed method is compared with two gradient-free methods (SLSQP, CMAES) and the GRAPE algorithm. In both tasks, the disclosed approach achieves faster convergence than all other three methods. Referring to FIG. 6A, a graph is shown of an example of loss over time data of the |+ [symbol] state. In the |+ [symbol] task, the final loss value from the disclosed method reads approximately 10⁻⁵, which is 18 times better than the second best result (i.e., SLSQP), as in FIG. 6A. Referring to FIG. 6B, a graph is shown of an example of loss over time data of the |Φ⁺ [symbol] state. In the |⁺ [symbol] task, the final loss value from the disclosed method reads 0.034, which is 3 times better than GRAPE and 6 times better than SLSQP, as shown in FIG. 6B.

Gate synthesis is more challenging than state preparation because the disclosed approach must engineer a full unitary gate Uₜₐᵣ instead of just mapping a single state to a target state. To this end a set of pairs

$${𝒮 = \{ ( \vert {x}_{j} 〉 , \vert {y}_{j} 〉 ) \}}_{j = 1}^{k}$$

is specified that completely determines Uₜₐᵣ in the sense that no unitary map U other than Uₜₐᵣ satisfies | [symbol] yⱼ|U|xⱼ [symbol] |=1 for all j=1, 2, . . . , k. Then, the loss function

$$ℒ = \frac{1}{k} {\sum }_{j = 1}^{k} {ℒ}_{j}$$

is considered, where each [symbol] ⱼ is defined as [symbol] = [symbol] ψ(T)|M|ψ(T) [symbol] , with quantum observable M= [symbol] −|yⱼ [symbol] [symbol] yⱼ| and initial state |xⱼ [symbol] . When [symbol] (v) is close to 0, the time evolution controlled by the parameter v is approximately Uₜₐᵣ.

The X gate and CNOT gate are widely used in digital quantum computing and supported by, for example, IBM® Qiskit. The two gates have been recovered on the AQAM as an example and, in both cases, the loss function can be readily computed on quantum devices (e.g., IBM® quantum machines).

The pulse duration is chosen to be comparable to the built-in ones in IBM® Qiskit: T=160 dt for X gate, and T=1200 dt for CNOT gate. Four methods (SLSQP, CMAES, GRAPE, and the disclosed approach) are applied to the gate synthesis tasks. Referring to FIG. 6C, an example graph is shown of the loss over time data of the synthesis of the X gate. In the synthesis of X gate, the final loss value from the disclosed method is 1.17×10⁻⁷, which is over 10⁴ times more accurate than the other three methods. Referring to FIG. 6D, an example graph is shown of the loss over time data of the synthesis of the CNOT gate. In the more involved task of synthesizing CNOT gate, the disclosed method returns a pulse sequence with loss 0.0172, while the results from other methods are no less than 0.2. It is worth noting that the loss of IBM® built-in calibrated pulses evaluated on IBM® machines are 0.019 for X gate and 0.043 for CNOT gate when no measurement error mitigation or state preparation error mitigation technique is applied.

The first differentiable analog quantum computing framework with a quantum stochastic gradient descent algorithm that allows directly optimizing the analog pulse control signal on quantum computers has been introduced. Since the computation history in a quantum system cannot be stored or reused for the purpose of computing gradients, a novel formulation for derivatives on quantum computers is constructed based on a forward pass with Monte Carlo sampling. With the disclosed algorithm according to the present disclosure, the disclosed method according to the present disclosure outperforms prior methods by orders of magnitude with better hardware efficiency on quantum optimization and control tasks.

Referring to FIG. 7, a processor-implemented method 700 for quantum optimization, using the quantum computing system 200 of FIG. 1 is shown. The system 200 for quantum optimization, may include a processor and a memory including instructions stored thereon, which, when executed by the processor 210, cause the quantum computing system 200 to perform the steps of method 700.

Initially, at step 702, the processor 210 causes the quantum computing system 200 to obtain an optimization problem represented by a time-dependent Hamiltonian, wherein the time-dependent Hamiltonian includes a trainable variable v. In aspects, the time-dependent Hamiltonian is parameterized by trainable variables. The quantum system evolves through the time following the Schrödinger equation

$$\frac{d}{d t} x ( t ) = - i H ( v , t ) x ( t ) .$$

The Hamiltonian is of the form

$$H ( v , t ) = {H}_{c} + {\sum }_{j = 1}^{m} {u}_{j} ( v , t ) {H}_{j} ,$$

where uⱼ(v, t) is differentiable with respect to v for any t∈[0, T]. v may be a weight and t may be a time parameter. H_{c} is an independent term, and may be a drifting Hamiltonian, e.g., it may represent the drifting dynamics of the quantum device.

Next, at step 704, the processor 210 causes the quantum computing system 200 to generate a loss function based on the time-dependent Hamiltonian.

Next, at step 706, the processor 210 causes the quantum computing system 200 to perform a differentiation of the loss function with respect to the trainable variable v for the time-dependent Hamiltonian.

Next, at step 708, the processor 210 causes the quantum computing system 200 to minimize the loss function to update the trainable variable v. In aspects, the processor 210 may cause the quantum computing system 200 to determine a differentiable loss function of the time-dependent Hamiltonian and optimize the differentiable loss function.

In aspects, the processor 210 may cause the quantum computing system 200 to generate an unbiased estimation of a gradient ∂ [symbol] /∂v.

Next, at step 710, the processor 210 causes the quantum computing system 200 to generate a control signal for a quantum device based on updating the trainable variable v. The control signal may be used to control quantum devices (e.g., quantum computers).

In aspects, the unbiased estimation of gradient ∂ [symbol] /∂v may be generated by setting two layers of mini-batches, including an integration mini-batch with size bᵢₙₜ; and an observation mini-batch with size b_{obs}. The integration mini-batch updates parameters according to an estimation of derivatives on the time, and the observation mini-batch is configured to repeat experiments to improve measurement results.

In aspects, the processor 210 may cause the quantum computing system 200 to transmit the control signal to the quantum device and program the quantum device using the control signal.

Although qubits are used as an example, the disclosed systems and methods could be applied to any quantum architecture.

Example uses of the disclosed systems and methods according to the present disclosure include eigensolvers, major computational tasks that can be represented as a Hamiltonian, gate synthesis, and/or deep learning.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For example, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the drawings.

The phrases “in an aspect,” “in aspects,” “in various aspects,” “in some aspects,” or “in other aspects” may each refer to one or more of the same or different example aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the present disclosure. Other elements, steps, methods, and techniques that are insubstantially different from those described above and/or in the appended claims are also intended to be within the scope of the present disclosure.

What is claimed is:

1. A system for differentiable analog quantum computing, the system comprising:
a processor; and
a memory, including instructions stored thereon, which, when executed by the processor, cause the system to:
obtain an optimization problem represented by a time-dependent Hamiltonian, wherein the time-dependent Hamiltonian includes a trainable variable v;
generate a loss function based on the time-dependent Hamiltonian;
perform a differentiation of the loss function with respect to the trainable variable v for the time-dependent Hamiltonian;
minimize the loss function to update the trainable variable v; and
generate a control signal for a quantum device based on updating the trainable variable v.

2. The system of claim 1, wherein the instructions, when executed by the processor, further cause the system to:
determine a differentiable loss function of the time-dependent Hamiltonian; and
optimize the differentiable loss function.

3. The system of claim 1, wherein the time-dependent Hamiltonian is parameterized by trainable variables.

4. The system of claim 1, wherein the quantum system evolves through the time following the Schrödinger equation
$$\frac{d}{d t} x ( t ) = - i H ( v , t ) x ( t ) .$$

5. The system of claim 1, wherein the Hamiltonian is of the form
$$H ( v , t ) = {H}_{c} + {\sum }_{j = 1}^{m} {u}_{j} ( v , t ) {H}_{j} .$$

6. The system of claim 5, wherein uⱼ(v, t) is differentiable with respect to v for any t∈[0, T].

7. The system of claim 1, wherein the Hamiltonian of the quantum device is of the form H(v, t), and is parameterized by tunable pulses.

8. The system of claim 1, wherein the instructions, when executed by the processor, further cause the system to:
generate an unbiased estimation of a gradient ∂ [symbol] /∂v.

9. The system of claim 1, wherein the instructions, when executed by the processor, further cause the system to:
estimate the integral using a Monte Carlo integration (MCI) technique.

10. The system of claim 8, wherein the unbiased estimation of gradient ∂ [symbol] /∂v is generated by setting two layers of mini-batches, including:
an integration mini-batch with size bᵢₙₜ; and
an observation mini-batch with size b_{obs},
wherein the integration mini-batch updates parameters according to an estimation of derivatives on the time, and
wherein the observation mini-batch is configured to repeat experiments to improve measurement results.

11. A method for differentiable analog quantum computing, the method comprising:
obtaining an optimization problem represented by a time-dependent Hamiltonian, wherein the time-dependent Hamiltonian includes a trainable variable v;
generating a loss function based on the time-dependent Hamiltonian;
performing a differentiation of the loss function with respect to the trainable variable v for the time-dependent Hamiltonian;
minimizing the loss function to update the trainable variable v; and
generating a control signal for a quantum device based on updating the trainable variable v.

12. The method of claim 11, further comprising:
determining a differentiable loss function of the time-dependent Hamiltonian; and
optimizing the differentiable loss function.

13. The method of claim 11, wherein the time-dependent Hamiltonian is parameterized by trainable variables.

14. The method of claim 11, wherein the quantum system evolves through the time following the Schrödinger equation
$$\frac{d}{d t} x ( t ) = - i H ( v , t ) x ( t ) .$$

15. The method of claim 11, wherein the Hamiltonian is of the form
$$H ( v , t ) = {H}_{c} + {\sum }_{j = 1}^{m} {u}_{j} ( v , t ) {H}_{j} .$$

16. The method of claim 15, wherein uⱼ(v, t) is differentiable with respect to v for any t∈[0, T].

17. The method of claim 11, wherein the Hamiltonian of the quantum device is of the form H(v, t), and is parameterized by tunable pulses.

18. The method of claim 11, further comprising:
generating an unbiased estimation of a gradient ∂ [symbol] /∂v.

19. The method of claim 11, further comprising:
estimating the integral using a Monte Carlo integration (MCI) technique.

20. A method for quantum optimization, the method comprising:
obtaining an ordinary differential equation (ODE) using a quantum simulator, where
$$H ( v , t ) = {H}_{c} + {\sum }_{j = 1}^{m} {u}_{j} ( v , t ) {H}_{j} ;$$
optimizing a loss function of the ODE to update the trainable variable v, using the quantum simulator, where [symbol] = [symbol] ψ(T)|M|ψ(T) [symbol] ;
estimating a gradient ∂ [symbol] /∂v using the quantum simulator;
updating the trainable variable v based on the estimated gradient ∂ [symbol] /∂v;
generating a control signal for a quantum computing device based on updating the trainable variable v; and
controlling the quantum computing device using the control signal.
